(19) United States
(12) Patent Application Publication
(10) Pub. No.: US 2024/0003730 A1
(43) Pub. Date: Jan. 4, 2024

(54) SENSOR SYSTEM, SENSOR DEVICE, AND SENSING METHOD

(71) Applicant: TRIPOD DESIGN CO., LTD., Tokyo (JP)

(72) Inventor: Satoshi NAKAGAWA, Tokyo (JP)

(73) Assignee: TRIPOD DESIGN CO., LTD., Tokyo (JP)

(21) Appl. No.: 18/025,301

(22) PCT Filed: Sep. 7, 2021
(86) PCT No.: PCT/JP2021/032884

§ 371 Date: Mar. 8, 2023

(30) Foreign Application Priority Data
Sep. 10, 2020 (JP) 2020-152435

(51) Int. Cl. G01F 23/24; G08C 15/00

(52) U.S. Cl. CPC G01F 23/241; G08C 15/00

(57) ABSTRACT

An object is to provide a sensor system including a sensor that operates on a self-sustaining power source. A sensor system includes one or more sensors and a computer device capable of making a communication connection with the sensor, the sensor including: a first conductive part and a second conductive part; and a functional part, the first conductive part and the functional part being connected to each other, the second conductive part and the functional part being connected to each other, the first conductive part and the second conductive part being not in contact with each other, and the functional part operating by an input voltage generated when at least a part of the first conductive part and the second conductive part comes into contact with water, and transmitting a signal to the computer device.

### TECHNICAL FIELD

The present invention relates to a sensor system including a sensor that operates on a self-sustaining power source.

### BACKGROUND ART

A river may overflow due to rain or the like to cause a flood. To predict the flood, for example, the state of the river is observed by installing a fixed point camera.

However, to predict the flood from the image of the fixed point camera, monitoring of the state of the river by humans is required. In addition, installing the fixed point camera and supplying power thereto are expensive.

For these reasons, observing the state of the river at multiple points using fixed point cameras has not been easy.

### SUMMARY OF INVENTION

### Technical Problem

At least one object of the present invention is to provide a sensor system including a sensor that operates on a self-sustaining power source.

### Solution to Problem

The present invention solves the above problem by any of the following [1] to [20].

[1] A sensor system comprising one or more sensors and a computer device capable of making a communication connection with the sensor, the sensor including: a first conductive part and a second conductive part; and a functional part, the first conductive part and the functional part being connected to each other, the second conductive part and the functional part being connected to each other, the first conductive part and the second conductive part being not in contact with each other, and the functional part operating by an input voltage generated when at least a part of the first conductive part and the second conductive part comes into contact with water, and transmitting a signal to the computer device;

[2] The sensor system according to [1], wherein the computer device includes a water level specifier configured to specify a water level at an installation location of the sensor corresponding to the received signal;

[3] A sensor system comprising one or more sensors and a computer device capable of making a communication connection with the sensor, the sensor including: a first conductive part and a second conductive part; and a functional part, the first conductive part and the functional part being connected to each other, the second conductive part and the functional part being connected to each other, the first conductive part and the second conductive part being not in contact with each other, and the functional part operating by an input voltage generated when at least a part of the first conductive part and the second conductive part comes into contact with water, specifying a water level at an installation location of the sensor, and transmitting a signal to the computer device;

[4] The sensor system according to any one of [1] to [3], wherein the sensor includes two or more pairs of the first conductive parts and the second conductive parts, and the functional part transmits, to the computer device, information for identifying the pair of the first conductive part and the second conductive part at least a part of which comes into contact with the water;

[5] The sensor system according to any one of [1] to [4], wherein the functional part transmits, to the computer device, information regarding an internal impedance and/or a voltage of the sensor when at least a part of the first conductive part and the second conductive part comes into contact with the water;

[6] The sensor system according to [4] or [5], wherein the computer device includes a water level rising speed calculator configured to calculate a speed at which the water level at the installation location of the sensor rises based on the received information and information on the specified water level;

[7] The sensor system according to any one of [1] to [6], wherein the functional part includes a voltage boost circuit or a voltage step-down circuit;

[8] The sensor system according to any one of [2] to [7], the sensor system comprising two or more of the sensors, wherein the computer device includes a water level rising estimator configured to estimate a rise in the water level downstream of the installation location of the sensor corresponding to the received signal according to the water level at the installation location of the sensor;

[9] The sensor system according to any one of [2] to [8], the sensor system comprising two or more of the sensors, wherein the computer device includes a flowing water speed calculator configured to calculate a flowing water speed between the installation locations of the sensors corresponding to the received signals based on information on the water level at the installation locations of the sensors;

[10] The sensor system according to any one of [2] to [9], the sensor system comprising the one or more sensors at each of opposite banks at a same position of a river, wherein the computer device includes a water level difference determiner configured to determine whether there is a difference between the water levels of the opposite banks;

[11] The sensor system according to any one of [1] to [10], wherein the computer device includes an outputter configured to output information regarding the received signal;

[12] The sensor system according to any one of [1] to [11], wherein the sensor includes a detection part configured to detect a state or a property of the water, and the functional part transmits information obtained by the detection part to the computer device;

[13] A sensor device comprising: a first conductive part and a second conductive part; and a functional part, the first conductive part and the functional part being connected to each other, the second conductive part and the functional part being connected to each other, the first conductive part and the second conductive part being not in contact with each other, and the functional part operating by an input voltage generated when at least a part of the first conductive part and the second conductive part comes into contact with water;

[14] The sensor device according to [13], comprising two or more pairs of the first conductive parts and the second conductive parts;

[15] The sensor device according to [13] or [14], comprising a covering member that covers a part or entirety of the sensor device, wherein the covering member includes a hole that allows for installation of the sensor device at an installation location;

[16] The sensor device according to any one of [13] to [15], wherein two or more colors are applied to an outer appearance of the sensor device perpendicularly to a longitudinal direction of the sensor device;

[17] The sensor device according to any one of [13] to [16], wherein the sensor device has a cylindrical main body, and includes the first conductive part and the second conductive part having a sheet shape on an inner surface of a cylinder;

[18] The sensor device according to any one of [13] to [16], wherein the sensor device has a tile-shaped main body, and includes the first conductive part and the second conductive part having a sheet shape on a plane of a tile;

[19] A sensing method in a sensor system comprising one or more sensors and a computer device capable of making a communication connection with the sensor, the sensor including: a first conductive part and a second conductive part; and a functional part, the first conductive part and the functional part being connected to each other, the second conductive part and the functional part being connected to each other, the first conductive part and the second conductive part being not in contact with each other, and the functional part operating by an input voltage generated when at least a part of the first conductive part and the second conductive part comes into contact with water, and transmitting a signal to the computer device;

[20] A sensing method in a sensor system comprising one or more sensors and a computer device capable of making a communication connection with the sensor, the sensor including: a first conductive part and a second conductive part; and a functional part, the first conductive part and the functional part being connected to each other, the second conductive part and the functional part being connected to each other, the first conductive part and the second conductive part being not in contact with each other, and the functional part operating by an input voltage generated when at least a part of the first conductive part and the second conductive part comes into contact with water, specifying a water level at an installation location of the sensor, and transmitting a signal to the computer device.

### Advantageous Effects of Invention

According to the present invention, it is possible to provide a sensor system including a sensor that operates on a self-sustaining power source.

### BRIEF DESCRIPTION OF DRAWINGS

FIG. 1 is a block diagram for explaining a sensor principle according to an embodiment of the present invention.

FIG. 2 is a block diagram illustrating a configuration of an electric power conversion part according to an embodiment of the present invention.

FIG. 3 is a circuit diagram for explaining a method for measuring the internal impedance of a sensor according to an embodiment of the present invention.

FIG. 4 is a diagram illustrating a relationship between time and a current I in a case where ON/OFF of a transistor in the system is switched according to an embodiment of the present invention.

FIG. 5 is a drawing illustrating an outer appearance of a sensor device according to an embodiment of the present invention.

FIG. 6 is a drawing illustrating an outer appearance of a sensor device according to an embodiment of the present invention.

FIG. 7 is a drawing illustrating an installation example of a sensor according to an embodiment of the present invention.

### DESCRIPTION OF EMBODIMENTS

Hereinafter, embodiments of the present invention will be described with reference to the accompanying drawings. Hereinafter, the description regarding effects is an aspect of the effects of the embodiments of the present invention, and is not limited to the description herein.

[Sensor Principle]

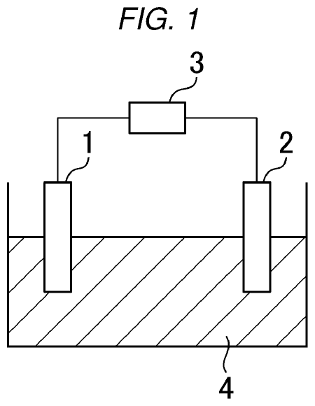

FIG. 1 is a block diagram for explaining a sensor principle according to an embodiment of the present invention. As shown in FIG. 1, the sensor includes a first conductive part 1, a second conductive part 2, a functional part 3, and a medium 4. The first conductive part 1 and the functional part 3 are electrically connected to each other, and the functional part 3 and the second conductive part 2 are electrically connected to each other. The term “electrically connected” means, for example, energizably connected by a conductive wire or the like. The functional part 3 operates by an input voltage generated when at least a part of the first conductive part 1 and the second conductive part 2 comes into contact with the medium 4.

The first conductive part 1 and the second conductive part 2 are not in contact with each other. The term “not in contact” refers to, for example, a state in which the first conductive part 1 and the second conductive part 2 are not in direct contact with each other.

The distance between the position where the first conductive part 1 is in contact with the medium 4 and the position where the second conductive part 2 is in contact with the medium 4 is preferably 1 cm or more, more preferably 10 cm or more, still more preferably 100 cm or more, and particularly preferably 1000 cm (10 m) or more.

It is preferable that both the first conductive part 1 and the second conductive part 2 have conductivity. Here, examples of the material of the first conductive part 1 and the second conductive part 2 include metal, a conductive polymer, carbon, and the like. Shapes of the first conductive part 1 and the second conductive part 2 are not particularly limited. The first conductive part 1 and the second conductive part 2 may have a rectangular parallelepiped shape, a round columnar shape (rod shape), a pyramid shape, a conical shape, a plate shape, or a string shape, and may have any shape.

The metal used for the first conductive part 1 and the second conductive part 2 can be appropriately selected from, for example, silver, copper, gold, aluminum, magnesium, zinc, nickel, platinum, tin, titanium, stainless steel, zinc oxide, magnesium oxide, oxides of the above-described metals, and the like. In addition, a predetermined metal may be coated with another metal different from the predetermined metal or another material having conductivity.

Materials of the first conductive part 1 and the second conductive part 2 may be different from each other, or may be the same as each other. For example, a round columnar rod made of stainless steel can be used for the first conductive part 1, and a round columnar rod made of zinc can be used for the second conductive part 2. In this case, the first conductive part 1 and the second conductive part 2 are connected to the functional part 3 or a voltage boost circuit/voltage step-down circuit by a conductive wire.

When polarization resistance is measured for at least one of the first conductive part 1 or the second conductive part 2 using an AC impedance method, the measured value is preferably 100Ω or more.

Here, a conductive part serving as a starting point of a current is defined as the first conductive part 1, and a conductive part serving as an ending point is defined as the second conductive part 2. Which conductive part functions as the first conductive part 1 is determined by a material of the conductive part or an environment surrounding the conductive part (for example, temperature, humidity, atmospheric pressure, pH, and the like). A chemical reaction occurs at an interface between the first conductive part 1 or the second conductive part 2 and the medium 4, and free electrons are generated in the conductive part.

For example, when different metals are used for the first conductive part 1 and the second conductive part 2, the conductive part made of a metal having a lower standard electrode potential is used as the first conductive part 1, and the conductive part made of a metal having a higher standard electrode potential is used as the second conductive part 2. In this case, electrons move from the second conductive part 2 toward the functional part 3, and electrons move from the functional part 3 toward the first conductive part 1. That is, a current is generated from the first conductive part 1 side to the second conductive part 2 side via the functional part 3. For example, in the second conductive part 2, the metal constituting the conductive part is eluted as a cation into the medium 4 to generate free electrons, and in the first conductive part 1, the cation in water of the medium 4 reacts with the electrons to be electrically neutralized.

The level of the standard electrode potential is determined by comparing relative values (relative values) of the standard electrode potentials of substances, and is not determined by using an absolute value of the standard electrode potential. For example, when substance A having a standard electrode potential of −5 V is compared with substance B having a standard electrode potential of +2 V, the standard electrode potential of substance A is low, and the standard electrode potential of substance B is high.

On the other hand, even when the same metal is used for the conductive parts, either one of the conductive parts functions as the first conductive part 1 and the other conductive part functions as the second conductive part 2 depending on the conditions of the surrounding environment of the conductive parts, such as temperature, humidity, atmospheric pressure, and pH, for example, and a current is generated. Therefore, when conditions such as ambient temperature, humidity, atmospheric pressure, and pH of the two conductive parts are changed, the one functioning as the first conductive part may function as the second conductive part, and the one functioning as the second conductive part may function as the first conductive part.

The electromotive force generated from the first conductive part 1 and the second conductive part 2 is preferably 0.9 V or less, more preferably 0.35 V or less, and still more preferably 0.25 V or less. The electromotive force generated from the first conductive part 1 and the second conductive part 2 is preferably 5 mV or more.

The functional part 3 is, for example, a part that executes a predetermined function by energization. The functional part 3 can include an electric consumption part that consumes electric power and exerts a predetermined function, an electric storage part that stores electricity generated in a conductive part, an output voltage conversion part or the like that converts a voltage to be output, such as a voltage boost circuit and a voltage step-down circuit, a control part such as a microcomputer that controls a circuit, and a communication part or the like capable of wirelessly communicating with other devices.

As the electric consumption part, for example, any of a light source such as an incandescent light bulb or a light emitting diode, a heat generator that emits heat, a sounding body that emits sound, a transmitter that emits a signal, and the like can be adopted. The electric storage part may be included in the voltage boost circuit or the voltage step-down circuit. A control part such as a microcomputer can control a circuit to release the electricity stored in the electric storage part under a predetermined condition. The released electricity is consumed by the electric consumption part. In addition, even in the control part such as a microcomputer, electric power is consumed slightly, and thus, it is possible to perform control so as to release the stored electricity while securing electric power necessary for activating the control part.

The functional part 3 may include any one of the electric consumption part, the electric storage part, the output voltage conversion part, the communication part, and the control part, and may be formed by combining any two or more of the power consumption part, the electric storage part, the output voltage conversion part, the communication part, and the control part. In addition, the functional part 3 may be formed by integrally forming any two or more of the electric consumption part, the electric storage part, the output voltage conversion part, the communication part, and the control part, or may be formed separately while electrically connecting any of the electric consumption part, the electric storage part, the output voltage conversion part, the communication part, and the control part.

Input impedance in the functional part 3 is preferably 1 kΩ or more, and more preferably 10 kΩ or more. In addition, the input impedance of the functional part 3 preferably has a non-linear current-voltage characteristic (I-V characteristic). The non-linear current-voltage characteristic refers to, for example, a case where, in a voltage change when a current flows through the functional part 3, the voltage value increases as a current value increases, but as the current value increases, an increase width of the voltage value required to increase the current value increases, and the voltage is not proportional to the current. In other words, the current value increases as the voltage value applied to the functional part 3 increases, but the degree of increase in the current value, which is increased by an increase in the voltage value, decreases as the voltage value increases, and the current value is not proportional to the voltage value. Since the input impedance in the functional part 3 has the non-linear current-voltage characteristic, the electromotive force generated between the first conductive part 1 and the second conductive part 2 is easily maintained.

The functional part 3 preferably has a function of converting output impedance. As a result, an influence on an input signal of the functional part 3 can be controlled.

In addition, the functional part 3 includes the electric storage part, and stores electric charge supplied from the first conductive part and/or the second conductive part. The control part performs control to release the stored electric charge in a time shorter than a time required to store the electric charge.

The lower limit value of the operating voltage of the functional part 3 is preferably 0.9 V or less. It is more preferable to operate at 0.35 V or less, and it is still more preferable to operate at 20 mV or less.

Water used as the medium 4 may be not only pure water but also water containing an electrolyte. The water used as the medium 4 may also contain soil, sand, mud, and the like. Furthermore, soil, sand, mud, and the like containing water can also be used as the medium 4. In addition, the medium 4 may have a sol form or a gel form as long as the medium 4 contains moisture. The medium 4 is not particularly limited as long as it can cause a chemical reaction at the interface with the first conductive part 1 or the second conductive part 2.

Among electrolytes contained in the water, the concentration of cations may be 1 mol/L or less, 0.6 mol/L or less, 0.1 mol/L or less, 0.01 mol/L or less, or 0.001 mol/L or less. There is no problem even if the medium 4 is not an electrolytic solution used in a battery.

Resistance value of the medium 4 between the first conductive part 1 and the second conductive part 2 is preferably 1 kΩ or more, and more preferably 10 kΩ or more.

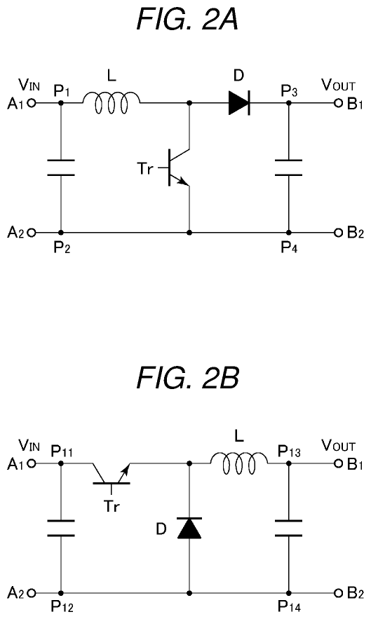

FIG. 2 is a block diagram illustrating a configuration of an electric power conversion part according to an embodiment of the present invention. FIG. 2A is a circuit diagram of a voltage boost circuit according to an embodiment of the present invention. A voltage boost circuit or a voltage step-down circuit is an example of the functional part 3, and includes an electric storage part.

As illustrated, an inductor L, a diode D, a transistor Tr, and a capacitor C are electrically connected. For example, an input terminal A1 is connected to the first conductive part 1, and an input terminal A2 is connected to the second conductive part 2. An output terminal B1 and an output terminal B2 are connected to an electric consumption part, a control part, and the like. The control part may be connected in parallel with the voltage boost circuit between the voltage boost circuit, and the first conductive part 1 and the second conductive part 2.

When an input voltage V_{IN} is applied while the transistor Tr is ON, electric energy is stored in the inductor L. The input voltage V_{IN} is the potential difference between a connection point P₁ and a connection point P₂. When the transistor Tr is OFF, the energy stored in the inductor L is added to the electric energy derived from the input voltage V_{IN}, and is output via the diode D. As a result, an output voltage V_{OUT}, which is the potential difference between a connection point P₃ and a connection point P₄, is higher than the input voltage V_{IN}. The voltage boost circuit may be based on the premise that the input voltage V_{IN} is a voltage lower than a predetermined voltage, and boost control may not be executed at a voltage higher than the predetermined voltage. The input voltage V_{IN} of the voltage boost circuit is preferably 5 mV or more. Note that ON/OFF of the transistor Tr is controlled by the control part.

FIG. 2B is a circuit diagram of a voltage step-down circuit according to an embodiment of the present invention. As illustrated, the transistor Tr, the inductor L, the diode D, and the capacitor C are electrically connected. For example, the input terminal A1 is connected to the first conductive part 1, and the input terminal A2 is connected to the second conductive part 2. The output terminal B1 and the output terminal B2 are connected to the electric consumption part, the control part, and the like. The control part may be connected in parallel with the voltage step-down circuit between the voltage step-down circuit, and the first conductive part 1 and the second conductive part 2.

When the transistor Tr is ON, electric energy is stored in the inductor L. The input voltage V_{IN} is the potential difference between a connection point P₁₁ and a connection point P₁₂, and the output voltage V_{OUT} is the potential difference between a connection point P₁₃ and a connection point P₁₄. In this case, the input voltage V_{IN} is substantially equal to the output voltage V_{OUT}. When the transistor Tr is OFF, the potential of at a connection point P₁₅ at the left end of the inductor L becomes lower than the potential at the connection point P₁₄, so that the output voltage V_{OUT} becomes a lower voltage. The voltage step-down circuit may be based on the premise that the input voltage V_{IN} is higher than a predetermined voltage, and step-down control may not be executed at a voltage lower than the predetermined voltage. Note that ON/OFF of the transistor Tr is controlled by the control part.

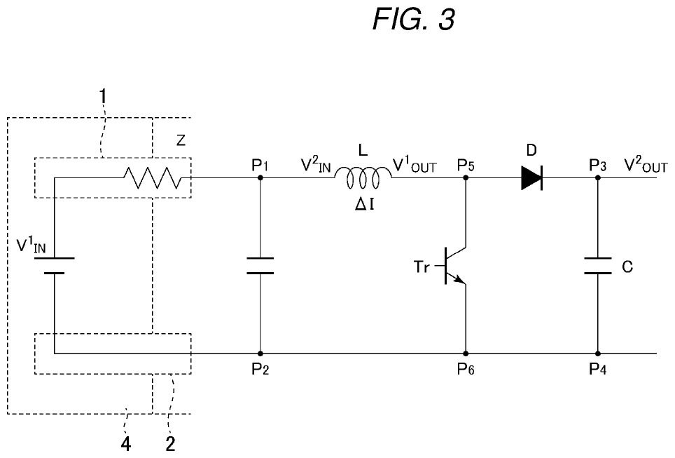

Next, a method for measuring the internal impedance of a sensor of the present invention will be described. FIG. 3 is a circuit diagram for explaining a method for measuring the internal impedance of a sensor according to an embodiment of the present invention. The potential difference between the first conductive part 1 and the second conductive part 2 can be defined as V¹_{IN}, and the potential difference between the connection point P₁ and the connection point P₂ can be defined as V²_{IN}. The potential difference between a connection point P₅ and a connection point P₆ can be defined as V¹_{OUT}, and the potential difference between the connection point P₃ and the connection point P₄ can be defined as V²_{OUT}. When power is generated by the sensor of the present invention, a current I flows between the first conductive part 1 and the second conductive part 2 in the direction of the connection point P₁ and the connection point P₅ by electromotive force V¹_{IN}.

As illustrated in FIG. 3, a voltage boost circuit is connected to the first conductive part 1 at the connection point P₁, and to the second conductive part 2 at the connection point P₂. In the voltage boost circuit, the inductor L, the diode D, the transistor Tr, and the capacitor C are electrically connected.

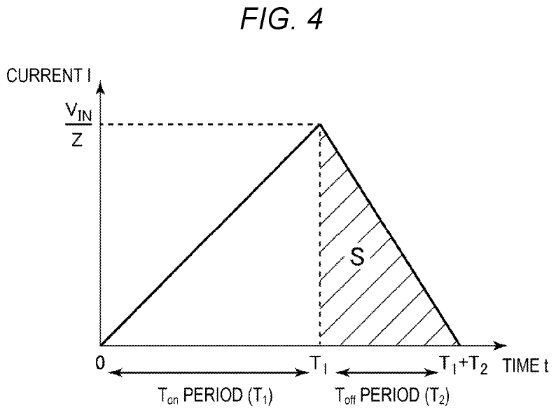

FIG. 4 is a diagram illustrating a relationship between time and the current I in a case where ON/OFF of the transistor in the sensor is switched according to an embodiment of the present invention. Here, the relationship between V_{OUT} and V²_{IN} can be expressed by Equation (1): V¹_{OUT}−V²_{IN}=−L1×dI/dt using the current I flowing through the inductor L and inductance L1. When the transistor Tr is ON, since V¹_{OUT}=0, Equation (2): V²_{IN}=L1×dI/dt can be derived. In this case, dI/dt is a positive value, and the current I increases with time. On the other hand, when the transistor Tr is OFF, since V¹_{OUT}>V²_{IN} is satisfied, it can be seen from Equation (1): V¹_{OUT}−V²_{IN}=−L1×dI/dt that dI/dt is a negative value. In this case, the current I decreases with time. The ON and OFF of the transistor Tr are periodically repeated.

Here, when the first conductive part 1, the second conductive part 2, and the medium 4 are regarded as one type of battery, it can be considered that the current I flows due to the electromotive force V¹_{IN}. In this case, when the internal impedance caused by the medium 4 is defined as Z, the relationship between an input voltage and the internal impedance can be expressed by Equation (3): V¹_{IN}=Z×I+V²_{IN}.

In addition, while the transistor Tr is OFF (hereinafter, referred to as a T_{OFF} period), the capacitor C is charged with electric charge Q by the current I. Assuming that the voltage increased at the connection point P₃ during the T_{OFF} period is ΔV and the capacitor capacitance of the capacitor C is C1, Equation (4): Q=∫Idt=C1×ΔV holds.

From Equations (2) and (3), V¹_{IN}=L1×dI/dt+Z×I is derived. By solving this equation, Equation (5): I(t)=V¹_{IN}/Z+A×e^{(-Z/L1×t)} is derived, where A is an integral constant. In a case where the time when the transistor Tr is switched from OFF to ON is t=0, as is clear from FIG. 4, the current I is zero when t=0. Therefore, when t=0 and I=0 are substituted into Equation (5), it is found that the relationship of A=−V¹_{IN}/Z holds. When this A=−V¹_{IN}/Z is substituted into Equation (5), Equation (6): I(t)=V¹_{IN}/Z×(1−e^{(-X/L1×t)}) can be derived. The current I while the transistor Tr is ON (hereinafter, referred to as a Tₒₙ period) can be calculated by Equation (6). When a time during which the transistor Tr is ON is sufficiently taken, the maximum value of the current I is V¹_{IN}/Z.

The current I when the Tₒₙ period ends and the T_{off} period starts (that is, when time T1 has elapsed since the transistor Tr was switched from OFF to ON) can be calculated by substituting t=T1 into Equation (6). This is because the current I has continuity as can be seen from FIG. 4. When replacing (1−e^{(-Z/L1×T1)}) with K (constant), the current I at t=T1 can be expressed as I(T1)=V¹_{IN}/Z×(1−e^{(-Z/L1×T1)})=K×V¹_{IN}/Z. Note that K satisfies the relationship of 0≤K<1, and when the value of Z/L1×T1 becomes sufficiently large, K can be approximated to 1.

Next, Equation (7): L1×dI/dt+Z×I=V¹_{IN}−V¹_{OUT} can be derived by Equations (1) and (3). Furthermore, by Equation (4), V²_{OUT} can be expressed by ∫Idt/C1+Vₛₜₐᵣₜ. Here, Vₛₜₐᵣₜ is the voltage of the capacitor C at the start of the T_{off} period (t=T1) and is a constant. If the threshold voltage of the diode D is V_{f}, Equation (8): V¹_{OUT}=V²_{OUT}+V_{f}=∫Idt/C1+Vₛₜₐᵣₜ+V_{f}=∫Idt/C1+V′ₒᵤₜ can be derived. Here, V′ₒᵤₜ=Vₛₜₐᵣₜ+V_{f} is a constant.

Furthermore, Equation (9): ∫Idt/C1+Z×I+L1×dI/dt=V¹_{IN}−V′ₒᵤₜ can be derived from Equations (7) and (8). By solving the differential equation of Equation (9), the current I during the T_{off} period can be expressed by a function of time t, the capacitor capacitance C1, the internal impedance Z, the inductance L1, V¹_{IN}, V′ₒᵤₜ, and K. When the start time of the T_{off} period is t=0, an initial value I(0) of the current I at that time is I(0)=K×V¹_{IN}/Z. When the T_{off} period ends (that is, time T2 elapses after the transistor Tr is switched from ON to OFF, and the current I becomes zero), I(T2)=0. The capacitor capacitance C1, the inductance L1, and V′ₒᵤₜ are constants, and when I(0) and T2 are measured, the values of V¹_{IN} and Z can be calculated.

Unlike the method described above, Z can be easily obtained. During the T_{off} period, since V¹_{OUT} is a voltage that is about 10 times larger than V²_{IN}, dI/dt also has a large value. In this case, ∫Idt in Equation (4) corresponds to the area of the triangle S in FIG. 4. Therefore, Equation (9): ∫Idt=K×V¹_{IN}/Z×T2/2=C1×ΔV is derived from Equation (4). Here, if the Tₒₙ time is sufficiently long, K≈1 can be approximated, and thus, when K=1 is substituted into Equation (9), Equation (10): V¹_{IN}/Z×T2/2=C1×ΔV is derived. C1 is a constant, and Z can be calculated from ΔV at the time point when the T_{off} period is sufficiently long (the time point when the current I becomes the minimum value), V¹_{IN} at the time point when the T_{off} period is sufficiently long (the time point when the current I becomes the minimum value), and T2 (the time when V¹_{OUT} becomes equal to V²_{IN}). Since V¹_{IN}=V²_{IN} at the time point when the T_{off} period is sufficiently long (the time point when the current I is consumed), V¹_{IN} can be specified by measuring V²_{IN}.

Note that the calculation of the internal impedance Z is executed by the control part.

[Sensor Device]

A sensor device according to the embodiment of the present invention has the above-described configuration and the above-described function. The sensor device includes the first conductive part and the second conductive part, and the functional part. In addition, the first conductive part and the functional part are connected, the second conductive part and the functional part are connected, and the first conductive part and the second conductive part are not in contact with each other. The functional part operates by the input voltage generated when at least a part of the first conductive part and the second conductive part comes into contact with the water. Furthermore, as will be described later, when the functional part of the sensor device operates, it is possible to specify a water level at an installation location of the sensor device, transmit a signal and information to a computer device, and the like.

As described above, with the sensor device having the above-described configuration and the above-described function, the sensor device can automatically operate without power supply from the outside when the water level of a river, an irrigation channel, or the like (hereinafter, referred to as a river or the like) as the installation location rises.

As will be described later, the functional part of the sensor device may also include a detection part that detects the state or property of the water. The functional part of the sensor device may transmit information obtained by the detection part to the computer device.

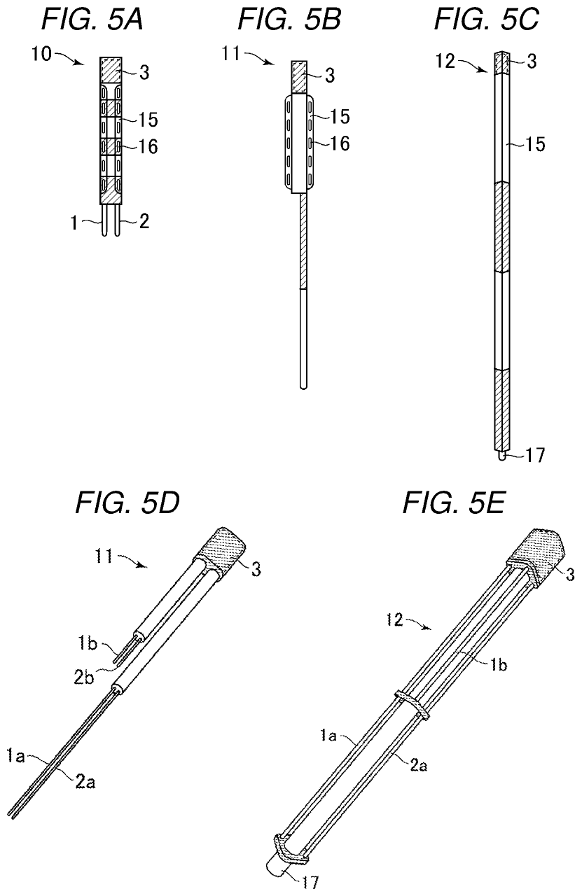

FIG. 5 is a drawing illustrating an outer appearance of the sensor device according to the embodiment of the present invention. As illustrated in FIG. 5, two or more colors may be applied to the outer appearance of the sensor device perpendicularly to a longitudinal direction of the sensor device. In FIGS. 5A to 5C, two colors are applied perpendicularly to the longitudinal direction of the sensor device. The sensor device may be colored in any number of types or colors as long as the sensor device has two or more colors, and can be designed as appropriate.

The sensor device is preferably installed such that the longitudinal direction of the sensor device is perpendicular to the water surface of the river or the like.

As described above, two or more colors are applied to the outer appearance of the sensor device perpendicularly to the longitudinal direction of the sensor device, and the sensor device is installed such that the longitudinal direction of the sensor device is perpendicular to the water surface of the river or the like. Therefore, the colors applied to the outer appearance of the sensor device make it easy to visually grasp how much the water level of the river or the like is.

In addition, the sensor device is preferably installed such that the functional part is on the upper side and the first conductive part and the second conductive part are on the lower side.

FIG. 5A illustrates the outer appearance of a sensor device 10 including a pair of the first conductive part 1 and the second conductive part 2. The sensor device 10 includes the pair of the first conductive part 1 and the second conductive part 2, and the functional part 3. In addition, in the sensor device 10, a part of the sensor device 10 is covered with a covering member 15. Furthermore, the covering member 15 is provided with a hole 16 that allows for installation of the sensor device 10 at the installation location. The material, shape, and the like of the covering member 15 are not particularly limited, and can be designed as appropriate. In addition, the number of holes, shape, position, and the like of the hole 16 are not particularly limited, and can be designed as appropriate.

FIG. 5B illustrates the outer appearance of a sensor device 11 including two pairs of the first conductive parts 1 and the second conductive parts 2. In addition, FIG. 5D illustrates the outer appearance of the sensor device 11 from which the covering member 15 is removed such that the first conductive parts 1 and the second conductive parts 2 of the sensor device 11 can be viewed.

As illustrated in FIG. 5D, the sensor device 11 includes the two pairs of the first conductive parts 1 and the second conductive parts 2, and the functional part 3. The length of one pair of the first conductive part and the second conductive part is different from the length of the other pair of the first conductive part and the second conductive part. In FIG. 5D, a first conductive part 1a and a second conductive part 2a are paired, and a first conductive part 1b and a second conductive part 2b are paired. In addition, the length of the pair of the first conductive part 1a and the second conductive part 2a is different from the length of the pair of the first conductive part 1b and the second conductive part 2b.

The sensor device 11 may include the same number of functional parts 3 as the number of pairs of the first conductive parts 1 and the second conductive parts 2. That is, in this case, two functional parts 3 may be provided. Each functional part 3 may be connected to the corresponding pair of the first conductive part 1 and the second conductive part 2 to be able to identify which pair of the first conductive part 1 and the second conductive part 2 has come into contact with the water. In this case, an identification number may be assigned to each functional part 3, so that the identification number may be used to identify which pair of the first conductive part 1 and the second conductive part 2 has come into contact with the water.

Alternatively, the sensor device 11 may include one functional part 3. The single functional part 3 may be able to identify which pair of the first conductive part 1 and the second conductive part 2 has come into contact with the water. In this case, an identification number may be assigned to each pair of the first conductive part 1 and the second conductive part 2, so that the identification number may be used to identify which pair of the first conductive part 1 and the second conductive part 2 has come into contact with the water.

In addition, in the sensor device 11, the entirety of the sensor device 11 is covered with the covering member 15 as illustrated in FIG. 5B. Furthermore, the covering member 15 is provided with the hole 16 that allows for installation of the sensor device 11 at the installation location. The material, shape, and the like of the covering member 15 are not particularly limited, and can be designed as appropriate. In addition, the number of holes, shape, position, and the like of the hole 16 are not particularly limited, and can be designed as appropriate.

Since the sensor device includes the covering member that covers a part or the entirety of the sensor device, and the covering member is provided with the hole that allows for installation of the sensor device at the installation location as described above, it is easy to install the sensor device on a wall surface or the like of a bridge girder, an embankment, and an irrigation channel.

FIG. 5C illustrates the outer appearance of a sensor device 12 including two pairs of the first conductive parts 1 and the second conductive parts 2, and a support column 17. In addition, FIG. 5E illustrates the outer appearance of the sensor device 13 from which the covering member 15 is removed such that the first conductive parts 1 and the second conductive parts 2 of the sensor device 12 can be viewed.

The sensor device 12 includes the two pairs of the first conductive parts 1 and the second conductive parts 2, and the functional part 3. The length of one pair of the first conductive part and the second conductive part is different from the length of the other pair of the first conductive part and the second conductive part. However, since the second conductive part 2b is provided on a surface opposite to the first conductive part 1a with the support column 17 of the sensor device 12 interposed therebetween, the second conductive part 2b is not illustrated in FIG. 5E. In FIG. 5E, the first conductive part 1a and the second conductive part 2a are paired, and the first conductive part 1b and the second conductive part 2b are paired. In addition, the length of the pair of the first conductive part 1a and the second conductive part 2a is different from the length of the pair of the first conductive part 1b and the second conductive part 2b.

The sensor device 12 may include the same number of functional parts 3 as the number of pairs of the first conductive parts 1 and the second conductive parts 2. That is, in this case, two functional parts 3 may be provided. Each functional part 3 may be connected to the corresponding pair of the first conductive part 1 and the second conductive part 2 to be able to identify which pair of the first conductive part 1 and the second conductive part 2 has come into contact with the water. In this case, an identification number may be assigned to each functional part 3, so that the identification number may be used to identify which pair of the first conductive part 1 and the second conductive part 2 has come into contact with the water.

Alternatively, the sensor device 12 may include one functional part 3. The single functional part 3 may be able to identify which pair of the first conductive part 1 and the second conductive part 2 has come into contact with the water. In this case, an identification number may be assigned to each pair of the first conductive part 1 and the second conductive part 2, so that the identification number may be used to identify which pair of the first conductive part 1 and the second conductive part 2 has come into contact with the water.

In the sensor device 12, a part of the sensor device 12 is covered with the covering member 15 as illustrated in FIG. 5C. The material, shape, and the like of the covering member 15 are not particularly limited, and can be designed as appropriate.

As illustrated in FIG. 5C, the sensor device 12 also includes the support column 17. The material, shape, and the like of the support column 17 are not particularly limited, and can be designed as appropriate. Since the sensor device 12 includes the support column 17, it is easy to install the sensor device 12 perpendicularly to the ground surface by a method of, for example, burying the support column 17 in the ground of a dry riverbed or the like.

Note that the sensor device may include two or more pairs of the first conductive parts 1 and the second conductive parts 2. The two or more pairs may be, for example, three pairs or four pairs. In addition, the length of one pair of the first conductive part and the second conductive part is preferably different from the lengths of the other pairs of the first conductive parts and the second conductive parts.

In a case where the sensor includes the three or more pairs of the first conductive parts and the second conductive parts, the lengths of all the pairs of conductive parts may be different, or the length of at least one pair of conductive parts may be different.

In addition, in the case where the sensor device includes two or more pairs of the first conductive parts and the second conductive parts, it is preferable that the functional part identifies the pair of the first conductive part and the second conductive part at least a part of which has come into contact with the water as described later.

Since the sensor device includes the two or more pairs of the first conductive parts and the second conductive parts as described above, it is possible to detect a rise in the water level of the river or the like in a stepwise manner.

Although FIG. 5 illustrates the three types of examples of the outer appearance of the sensor device, the outer appearance of the sensor device can be designed as appropriate. That is, the number of pairs of the first conductive parts and the second conductive parts of the sensor device, the number of functional parts, the shape of the covering part, the colors, the presence or absence of the support column, the length of the sensor device, the lengths of the first conductive part and the second conductive part of the sensor device, and the like can be designed as appropriate.

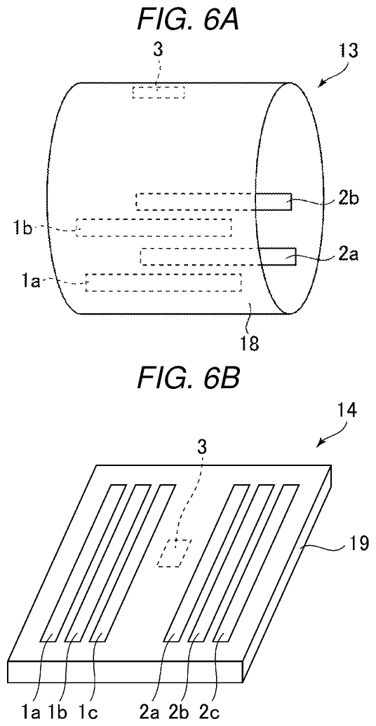

For example, the outer appearance of the sensor device may look like a part of a building or the like, such as a pipe or a tile, as a whole. FIG. 6 is a diagram illustrating the outer appearance of the sensor device according to the embodiment of the present invention. In FIG. 6A, the outer appearance of the sensor device looks like a pipe. In addition, in FIG. 6B, the outer appearance of the sensor device looks like a tile.

As illustrated in FIG. 6A, a sensor device 13 has a cylindrical main body 18. The sensor device 13 includes the first conductive parts 1 and the second conductive parts 2 having a sheet shape on an inner surface of a cylinder as the main body. In addition, as illustrated in the drawing, the functional part 3 may be provided on the inner surface of the cylinder of the sensor device 13. In FIG. 6A, the sensor device 13 includes two pairs of the first conductive parts 1 and the second conductive parts 2. In FIG. 6A, the first conductive part 1a and the second conductive part 2a are paired, and the first conductive part 1b and the second conductive part 2b are paired.

Since the sensor device 13 has the cylindrical main body 18, the sensor device 13 can be connected to a pipe such as a drain pipe. When the sensor device 13 is connected to the pipe, a component commonly used for pipe connection may be used. In addition, when the sensor device 13 is connected to the pipe, an inner diameter of the sensor device 13 is preferably equal to an inner diameter of the connected pipe.

Since the sensor device has the cylindrical main body and includes the first conductive parts and the second conductive parts having a sheet shape on the inner surface of the cylinder as described above, it is possible to connect the sensor device to the pipe and detect a rise in a water level in the pipe. In addition, it is also possible to sense that no water flows in the pipe through which water normally flows. When it is sensed that no water flows in the pipe, it is found that some kind of abnormality such as clogging or breakage may have occurred in the pipe.

As illustrated in FIG. 6B, a sensor device 14 has a tile-shaped main body 19. The sensor device 14 includes the first conductive parts 1 and the second conductive parts 2 having a sheet shape on a plane of a tile as the main body. In addition, as illustrated in the drawing, the functional part 3 may be provided inside the tile of the sensor device 14. In FIG. 6B, the sensor device 14 includes three pairs of the first conductive parts 1 and the second conductive parts 2. In FIG. 6B, the first conductive part 1a and the second conductive part 2a are paired, the first conductive part 1b and the second conductive part 2b are paired, and a first conductive part 1c and a second conductive part 2c are paired.

Since the sensor device 14 has the tile-shaped main body 19, it is easy to install the sensor device 14 at various places other than the wall surface of the bridge girder, the embankment, and the irrigation channel. For example, the sensor device 14 can be easily installed in town such as under an eaves of a house or a wall of a house.

When the sensor device 14 is installed, the sensor device 14 may be installed such that the longitudinal direction of the first conductive parts 1 and the second conductive parts 2 is perpendicular to the water surface of the river or the like or the ground surface. The sensor device 14 includes the two or more pairs of the first conductive parts 1 and the second conductive parts 2, and is installed such that the longitudinal direction of the first conductive parts 1 and the second conductive parts 2 is perpendicular to the water surface of the river or the like or the ground surface. Therefore, when the water surface of the river or the like rises, or when the water surface of the flooded ground rises, the contact area of the first conductive parts 1 and the second conductive parts 2 with the water increases, so that a large amount of voltage can be generated.

Alternatively, when the sensor device 14 is installed, the sensor device 14 may be installed such that the longitudinal direction of the first conductive parts 1 and the second conductive parts 2 is parallel to the water surface of the river or the like or the ground surface. The sensor device 14 includes the two or more pairs of the first conductive parts 1 and the second conductive parts 2, and is installed such that the longitudinal direction of the first conductive parts 1 and the second conductive parts 2 is parallel to the water surface of the river or the like or the ground surface. Therefore, when the water surface of the river or the like rises, or when the water surface of the flooded ground rises, it is possible to detect the rise in the water level in a stepwise manner.

Since the sensor device has the tile-shaped main body and includes the first conductive parts and the second conductive parts having a sheet shape on the plane of the tile as described above, it is easy to install the sensor device at various places and detect the situation of flooding in various places.

[Sensor System]

A sensor system according to the embodiment of the present invention is a sensor system utilizing the above-described sensor. The sensor system includes at least one or more of the above-described sensors. In addition, the sensor has the above-described configuration and function.

(First Embodiment of Sensor System)

A sensor system according to a first embodiment of the present invention includes the above-described sensor. In addition, the sensor has the above-described configuration and the above-described function. Here, the sensor system includes the sensor device 10 described above. The sensor device 10 includes the single pair of the first conductive part and the second conductive part.

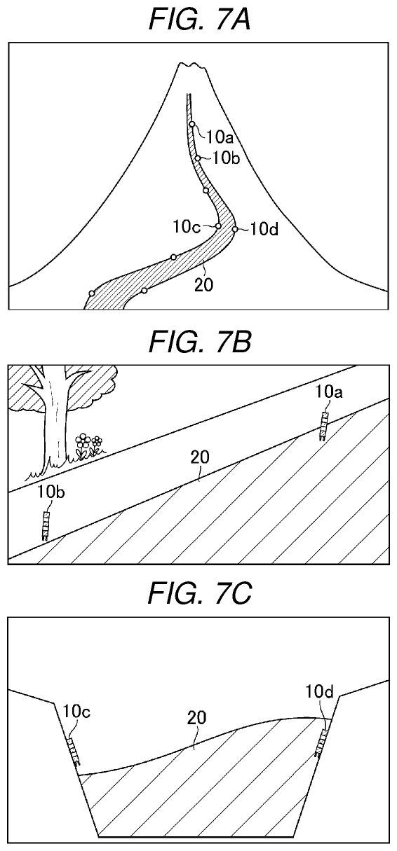

FIG. 7 is a drawing illustrating installation examples of sensors according to the embodiment of the present invention.

In the sensor system of the present invention, as illustrated in FIG. 7A, it is preferable to install a plurality of sensors from the upper stretch to the lower stretch of a river. In FIG. 7A, a portion denoted by a circle represents a portion where a sensor is installed. In FIG. 7A, a plurality of the sensor devices 10 are installed from the upper stretch to the lower stretch of a river 20.

Each sensor is preferably installed such that the longitudinal direction of the sensor is perpendicular to the water surface of the river. Furthermore, the sensor is preferably installed such that the functional part 3 is on the upper side and the first conductive part 1 and the second conductive part 2 are on the lower side.

The functional part 3 of the sensor operates by the input voltage generated when at least a part of the first conductive part 1 and the second conductive part 2 comes into contact with water. The operation of the functional part 3 of the sensor causes the communication part of the sensor to transmit the signal to the computer device. The computer device specifies the water level at the installation location of the sensor corresponding to the received signal.

Here, the computer device is not particularly limited as long as the computer device includes a communication part and a control part. Examples thereof include a server device, a desktop/notebook personal computer, a tablet terminal, a smartphone, and a conventional mobile phone. In a case where the computer device is the desktop/notebook personal computer, the tablet terminal, the smartphone, the conventional mobile phone, or the like (hereinafter, referred to as a terminal device), it is preferable to install a dedicated application (hereinafter, referred to as a sensor system application) for using the sensor system of the present invention.

In addition, the computer device preferably includes a storage part. The storage part of the computer device preferably stores information regarding the water level of the river or the like when the sensor operates (hereinafter, referred to as a warning water level in the first embodiment), for each sensor installation location. Since the computer device stores the information regarding the warning water level for each sensor installation location, it is easy to specify the water level at the installation location of the sensor corresponding to the received signal.

The computer device may be able to identify the sensor corresponding to the received signal. For example, an identification number for identifying each sensor may be assigned to the sensor, and when the sensor transmits the signal to the computer device, information regarding the identification number may also be transmitted. The computer device may be able to specify to which sensor the received signal corresponds on the basis of the received information regarding the identification number. In addition, the computer device may store information regarding each sensor installation location and the information regarding the warning water level at each sensor installation location in association with the identification number of the sensor.

For example, when the water level of the river 20 at the installation location of a sensor device 10a in FIG. 7A rises due to rain or the like, and the first conductive part 1 and the second conductive part 2 of the sensor device 10a come into contact with the water of the river 20, the sensor device 10a operates to transmit the signal to the computer device. In the computer device, the water level at the installation location of the sensor device 10a is specified to have reached the warning water level at the installation location of the sensor device 10a.

Note that the signal may be transmitted when the first conductive part 1 and the second conductive part 2 of the sensor come into contact with water from a state where the first conductive part 1 and the second conductive part 2 are not in contact with the water, or the signal may continue to be transmitted while the first conductive part 1 and the second conductive part 2 of the sensor are in contact with the water.

The term continue is not limited to being temporally continuous or at regular intervals. For example, the signal may be transmitted at different intervals depending on a power supply situation from the first conductive part 1 and the second conductive part 2 of the sensor.

By continuing to transmit the signal while the first conductive part 1 and the second conductive part 2 of the sensor are in contact with the water, it is possible to continue to specify whether or not the water level of the river at the installation location of the sensor is equal to or higher than the warning water level.

As described above, the sensor includes the first conductive part and the second conductive part, and the functional part, and the functional part operates by the input voltage generated when at least a part of the first conductive part and the second conductive part comes into contact with water, and transmits the signal to the computer device. As a result, without monitoring by humans or power supply from the outside, it is possible to detect a rise in the water level at the installation location of the sensor when the water level of the river or the like at the installation location of the sensor rises.

In addition, as described above, the computer device includes a water level specifier that specifies the water level at the installation location of the sensor corresponding to the received signal. Therefore, when the water level of the river or the like at the installation location of the sensor rises, the water level at the installation location of the sensor can be specified.

Alternatively, the water level may be specified in the functional part 3 of the sensor. In this case, the functional part 3 of the sensor operates by the input voltage generated when at least a part of the first conductive part 1 and the second conductive part 2 comes into contact with the water, and specifies the water level at the installation location of the sensor. The communication part of the sensor transmits the signal to the computer device.

In the case where the functional part of the sensor specifies the water level, the sensor may include a storage part, the control part, and the communication part. The storage part of the sensor may store the information regarding the warning water level at the installation location of the sensor, and the control part of the sensor may specify the water level at the installation location of the sensor. Furthermore, the communication part of the sensor may transmit information regarding the specified water level at the installation location of the sensor together with the signal.

In this case, the computer device may also be able to identify the sensor corresponding to the received signal. For example, as described above, the identification number may be assigned to the sensor, and the computer device may be able to specify to which sensor the received signal corresponds on the basis of the identification number.

Furthermore, the signal and the information regarding the specified water level at the installation location of the sensor may be transmitted when the first conductive part 1 and the second conductive part 2 of the sensor come into contact with the water from a state where the first conductive part 1 and the second conductive part 2 are not in contact with the water, or the signal and the information regarding the specified water level at the installation location of the sensor may continue to be transmitted while the first conductive part 1 and the second conductive part 2 of the sensor are in contact with the water.

The term continue is not limited to being temporally continuous or at regular intervals as described above. For example, the signal may be transmitted at different intervals depending on a power supply situation from the first conductive part 1 and the second conductive part 2 of the sensor.

As described above, the sensor includes the first conductive part and the second conductive part, and the functional part, and the functional part operates by the input voltage generated when at least a part of the first conductive part and the second conductive part comes into contact with the water, specifies the water level at the installation location of the sensor, and transmits the signal to the computer device. As a result, without monitoring by humans or power supply from the outside, it is possible to specify the water level at the installation location of the sensor when the water level of the river or the like at the installation location of the sensor rises.

FIG. 7B is a cross-sectional view of the installation locations of the sensor device 10a and a sensor device 10b of FIG. 7A in a direction perpendicular to the water surface of the river 20. The sensor device 10a and the sensor device 10b are installed at the embankment of the river. The sensor device 10a is installed upstream of the sensor device 10b. The water of the river flows from the upper stretch to the lower stretch. Thus, when the water level of the upper stretch of the river rises, the water level of the lower stretch is likely to rise thereafter.

Therefore, when the water level of the river 20 at the installation location of the sensor device 10a reaches the warning water level, and the sensor device 10a transmits the signal to the computer device, the computer device estimates the rise in the water level downstream of the installation location of the sensor device 10a according to the water level of the river 20 at the installation location of the sensor device 10a.

For example, in a case where the water level at the installation location of the sensor device 10a is a predetermined value or more, the computer device may estimate the rise in the water level downstream of the installation location of the sensor device 10a. At this time, the water level at the installation location of the sensor device 10b, which is downstream of and nearest to the sensor device 10a, may be estimated to rise, the water levels at the installation locations of the sensors that are installed downstream of the sensor device 10a and within a predetermined range may be estimated to rise, or the water levels at the installation locations of all the sensors installed downstream of the sensor device 10a may be estimated to rise.

Alternatively, the water level downstream of the installation location of the sensor device 10a may be estimated to rise according to the water level at the installation location of the sensor device 10a and an incline between the installation location of the sensor device 10a and the installation location of the sensor device 10b. For example, in a case where the water level at the installation location of the sensor device 10a is a predetermined value or more, and the incline between the installation location of the sensor device 10a and the installation location of the sensor device 10b is a predetermined value or more, the water level downstream of the installation location of the sensor device 10a may be estimated to rise.

In addition to the water level at the installation location of the sensor device and the incline between the installation locations of the sensor devices, the downstream water level may be estimated to rise according to various information such as a flowing water speed between the installation locations of the sensors described later.

As described above, the sensor system includes the two or more sensors, and the computer device includes a water level rising estimator that estimates the rise in the water level downstream of the installation location of the sensor corresponding to the received signal according to the water level at the installation location of the sensor. Therefore, it is possible to estimate the rise in the water level in a downstream area before the water level in the downstream area actually rises. That is, the residents in the downstream area can evacuate before the downstream area is actually damaged by a flood.

In addition, in FIG. 7B, in a case where the river 20 at the installation location of the sensor device 10a reaches the warning water level and the river 20 at the installation location of the sensor device 10b subsequently reaches the warning water level, the computer device can calculate the flowing water speed between the installation locations of the sensor device 10a and the sensor device 10b on the basis of the information on the water level at the installation locations of the sensor device 10a and the sensor device 10b.

Specifically, it is possible to calculate the flowing water speed between the installation locations of the sensor device 10a and the sensor device 10b on the basis of the information regarding the water level at the installation locations of the sensor device 10a and the sensor device 10b, information regarding a distance between the installation locations of the sensor device 10a and the sensor device 10b, information regarding a difference in time when the signals are received from the sensor device 10a and the sensor device 10b, information regarding a rainfall between the installation locations of the sensor device 10a and the sensor device 10b, information regarding an amount of water loss between the installation locations of the sensor device 10a and the sensor device 10b, and the like.

For example, in a case where the warning water levels at the installation locations of the sensor device 10a and the sensor device 10b have the same value, and there is no rain and no water loss between the installation locations of the sensor device 10a and the sensor device 10b, the flowing water speed between the installation locations of the sensor device 10a and the sensor device 10b can be calculated by dividing the distance between the installation locations of the sensor device 10a and the sensor device 10b by the difference in time when the signals are received from the sensor device 10a and the sensor device 10b.

In this case, the computer device preferably stores the information regarding the rainfall between the installation locations of the sensors and the information regarding the amount of water loss between the installation locations of the sensors.

In a case where the flowing water speed between the installation locations of the sensors increases, it is estimated that the water level in the downstream area from the sensors rises more quickly.

As described above, the sensor system includes the two or more sensors, and the computer device includes a flowing water speed calculator that calculates the flowing water speed between the installation locations of the sensors corresponding to the received signals on the basis of the information on the water level at the installation locations of the sensors. Therefore, the rise in the water level in the downstream area from the installation locations of the sensors can be more accurately estimated.

FIG. 7C is a cross-sectional view of the installation locations of a sensor device 10c and a sensor device 10d of FIG. 7A in the direction perpendicular to the water surface of the river 20. The sensor device 10c and the sensor device 10d are installed at the opposite banks of the embankment at the same position of the river 20. The sensor device 10c is installed at an inner curve of the river 20, and the sensor device 10d is installed at an outer curve of the river 20.

In a case where the river is curved, the water level at the outer curve of the river may be higher than the water level at the inner curve of the river depending on the flowing water speed of the river. Therefore, as illustrated in FIG. 7C, there may be a case where the installation location of the sensor device 10d has reached the warning water level while the installation location of the sensor device 10c has not reached the warning water level. In such a case, the computer device determines that there is a difference between the water levels of the opposite banks of the river 20 at the installation locations of the sensor device 10c and the sensor device 10d.

When it is determined that there is a difference between the water levels of the opposite banks of the river at the installation locations of the sensors, it is found that the river at the installation locations of the sensors is highly likely to have an increased flowing water speed, and a flood is highly likely to occur on the outer side of the river.

As described above, the sensor system includes the one or more sensors at each of the opposite banks at the same position of the river, and the computer device includes a water level difference determiner that determines whether there is a difference between the water levels of the opposite banks. Therefore, it is found that the river at the installation locations of the sensors is highly likely to have an increased flowing water speed, and a flood is highly likely to occur on the outer side of the river. It can be determined that the residents on the outer side of the river should be preferentially evacuated over the residents on the inner side of the river.

In the sensor system of the present invention, when the computer device receives the signal, the computer device may output information regarding the received signal.

For example, in a case where the computer device is the server device, the server device may transmit the information regarding the received signal to the terminal device. The terminal device may output a voice notifying that the signal has been received, may display a screen notifying that the signal has been received, or may display the information regarding the received signal.

Alternatively, in a case where the computer device is the terminal device, the terminal device may output the voice notifying that the signal has been received, may display the screen notifying that the signal has been received, or may display the information regarding the received signal.

The information regarding the received signal may include information regarding reception of the signal from the sensor, information regarding the installation location of the sensor corresponding to the received signal, information regarding the water level of the installation location of the sensor, information regarding a flow area where the water level is estimated to rise by the water level rising estimator, information regarding the flowing water speed calculated by the flowing water speed calculator, information regarding whether or not the location is determined by the water level difference determiner that there is a difference between the water levels of the opposite banks, and the like. In addition, the information regarding the received signal may include information regarding a speed at which the water level rises, calculated by a water level rising speed calculator as described later.

As described above, the computer device includes an outputter that outputs the information regarding the received signal. Therefore, it is possible to easily grasp the situation of the river at the installation location of the sensor corresponding to the received signal.

In the first embodiment of the sensor system, the sensor system includes the sensor device 10, but may include a different sensor from the sensor device 10. The different sensor from the sensor device 10 may be, for example, the sensor including two or more pairs of the first conductive parts and the second conductive parts, or the sensor where the hole that allows for installation of the sensor device at the installation location is not provided in the covering member. Alternatively, the different sensor from the sensor device 10 may be, for example, the sensor having the cylindrical main body or the sensor having the tile-shaped main body.

In addition, in a case where the sensor system includes the sensor including the two or more pairs of the first conductive parts and the second conductive parts, and/or a sensor that transmits information regarding the internal impedance and/or the voltage of the sensor as described later, the computer device can calculate the speed at which the water level at the installation location of the sensor rises.

In addition, in the first embodiment of the sensor system, the plurality of sensors are installed at the river. However, a place where the sensors are installed and the number of sensors to be installed are not limited thereto, and can be designed as appropriate.

(Second Embodiment of Sensor System)

A sensor system according to a second embodiment of the present invention includes the above-described sensor. In addition, the sensor has the above-described configuration and the above-described function. Here, the sensor system includes the sensor device 11. The sensor device 11 includes the two pairs of the first conductive parts and the second conductive parts, and the length of one pair of the first conductive part and the second conductive part is different from the length of the other pair of the first conductive part and the second conductive part.

Here, it is assumed that the functional part 3 of the sensor device 11 can identify which pair of the first conductive part 1 and the second conductive part 2 (hereinafter, referred to as a pair of conductive parts) has come into contact with the water. A method for identifying the pair of conductive parts in contact with the water is not particularly limited, and can be designed as appropriate. For example, as described above, the identification number may be assigned to each pair of conductive parts, and when the sensor transmits the signal to the computer device, information regarding the identification number may also be transmitted. The computer device may be able to specify to which sensor and pair of conductive parts the received signal corresponds on the basis of the received information regarding the identification number. Hereinafter, it is assumed that the identification number is assigned to each pair of conductive parts in the second embodiment.

The sensor is preferably installed at the river or the like. In addition, the sensor is preferably installed such that the longitudinal direction of the sensor is perpendicular to the water surface of the river or the like. Furthermore, the sensor is preferably installed such that the functional part 3 is on the upper side and the first conductive part 1 and the second conductive part 2 are on the lower side.

As illustrated in FIG. 5D, the pair of the first conductive part 1a and the second conductive part 2a (hereinafter, referred to as a pair a of conductive parts) of the sensor device 11 is longer than the pair of the first conductive part 1b and the second conductive part 2b (hereinafter, referred to as a pair b of conductive parts). Therefore, when the water level of the river or the like where the sensor device 11 is installed rises, the pair a of conductive parts comes into contact with the water earlier than the pair b of conductive parts.

The functional part 3 of the sensor device 11 operates by the input voltage generated when at least a part of the pair a of conductive parts comes into contact with the water of the river or the like. When the functional part 3 of the sensor device 11 operates, the communication part of the sensor device 11 transmits the signal and information for identifying the pair of conductive parts in contact with the water (in this case, the information regarding the identification number of the pair a of conductive parts) to the computer device. The computer device specifies the water level at the installation location of the sensor corresponding to the received signal.

In a case where the water level of the river where the sensor device 11 is installed further rises, and at least a part of the pair b of conductive parts comes into contact with the water, the communication part of the sensor device 11 transmits the information for identifying the pair of conductive parts in contact with the water (in this case, the information regarding the identification number of the pair b of conductive parts) to the computer device. The computer device specifies the water level at the installation location of the sensor corresponding to the received information.

Here, the computer device is not particularly limited as long as the computer device includes a communication part and a control part. Examples thereof include a server device and a terminal device. In a case where the computer device is the terminal device, it is preferable to install a sensor system application.

In addition, the computer device preferably includes a storage part. The storage part of the computer device preferably stores information regarding the water level of the river or the like when each pair of conductive parts of the sensor comes into contact with water, for each sensor installation location.

For example, here, the storage part preferably stores information regarding the water level of the river or the like when the pair a of conductive parts comes into contact with the water (hereinafter, referred to as a warning water level in the second embodiment), and information regarding the water level of the river or the like when the pair b of conductive parts comes into contact with the water (hereinafter, referred to as a flooding danger water level in the second embodiment), at the installation location of the sensor device 11.

Since the computer device stores the information regarding the water level of the river or the like when each pair of conductive parts of the sensor comes into contact with the water for each sensor installation location, it is easy to specify the water level at the installation location of the sensor corresponding to the received signal and the received information.

Alternatively, the functional part of the sensor may specify the water level at the installation location of the sensor. In this case, the description of the first embodiment of the sensor system can be adopted within a necessary range as to how to specify the water level and transmit the information.

Note that the signal and the information for identifying the pair of conductive parts in contact with the water may be transmitted when the pair of conductive parts of the sensor comes in contact with the water from a state where the pair of conductive parts is not in contact with the water, or may continue to be transmitted while the pair of conductive parts of the sensor is in contact with the water.

The term continue is not limited to being temporally continuous or at regular intervals. For example, the signal and the information for identifying the pair of conductive parts in contact with the water may be transmitted at different intervals depending on a power supply situation from the first conductive part 1 and the second conductive part 2 of the sensor.

By continuing to transmit the signal and the information for identifying the pair of conductive parts in contact with the water while the first conductive part 1 and the second conductive part 2 of the sensor are in contact with the water, it is possible to continue to specify whether or not the water level of the river at the installation location of the sensor is equal to or higher than the warning water level or the flooding danger water level.

As described above, the sensor includes the two or more pairs of the first conductive parts and the second conductive parts, and the functional part transmits, to the computer device, the information for identifying the pair of the first conductive part and the second conductive part at least a part of which has come into contact with the water. Therefore, it is possible to specify how much the water level at the installation location of the sensor has increased. In addition, the residents in the vicinity of the installation location of the sensor can take evacuation actions according to the situation of the river or the like, such as starting preparation for evacuation when the river or the like reaches the warning water level and actually starting evacuation when the river or the like reaches the flooding danger water level.

In addition, the computer device may calculate the speed at which the water level of the river or the like at the installation location of the sensor rises on the basis of a time when the water level of the river or the like at the installation location of the sensor reaches the warning water level and information on the water level thereof, and a time when the water level of the river or the like at the installation location of the sensor reaches the flooding danger water level and information on the water level thereof.

The speed at which the water level at the installation location of the sensor rises can be calculated, for example, by dividing a difference between the flooding danger water level and the warning water level at the installation location of the sensor, by a time required for the water level to rise from the warning water level to the flooding danger water level. At this time, the speed at which the water level at the installation location of the sensor rises may be calculated in consideration of the information regarding the rainfall at the installation location of the sensor, the information regarding the water loss amount, and the like.

As described above, the computer device includes the water level rising speed calculator that calculates the speed at which the water level at the installation location of the sensor rises on the basis of the received information and the specified water level information. Therefore, the speed at which the water level at the installation location of the sensor rises can be specified. As the speed at which the water level at the installation location of the sensor rises increases, it is found that the residents in the vicinity of the installation location of the sensor need to evacuate more quickly.

In the sensor system of the present invention, when the computer device receives the signal, the computer device may output information regarding the received signal.

For example, in a case where the computer device is the server device, the server device may transmit the information regarding the received signal to the terminal device. The terminal device may output a voice notifying that the signal has been received, may display a screen notifying that the signal has been received, or may display the information regarding the received signal.

Alternatively, in a case where the computer device is the terminal device, the terminal device may output the voice notifying that the signal has been received, may display the screen notifying that the signal has been received, or may display the information regarding the received signal.

In addition, the information regarding the received signal may include information regarding reception of the signal from the sensor, information regarding the installation location of the sensor corresponding to the received signal, information regarding the water level of the installation location of this sensor, information regarding the speed at which the water level rises calculated by the water level rising speed calculator, and the like.

Furthermore, in a case where the sensor system includes two or more of the sensors, the information regarding the received signal may include information regarding a flow area where the water level is estimated to rise by the water level rising estimator, information regarding the flowing water speed calculated by the flowing water speed calculator, information regarding whether or not the location is determined by the water level difference determiner that there is a difference between the water levels of the opposite banks, and the like. The description of the first embodiment of the sensor system can be adopted within a necessary range as to the method of calculating each information and the like.

In the second embodiment of the sensor system, the sensor system includes the sensor device 11, but may include a different sensor from the sensor device 11. The different sensor from the sensor device 11 may be, for example, the sensor including the three or more pairs of the first conductive parts and the second conductive parts, the sensor where the hole that allows for installation of the sensor device at the installation location is not provided in the covering member, the sensor having the cylindrical main body, or the sensor having the tile-shaped main body. The different sensor may also be the sensor that transmits information regarding the internal impedance and/or the voltage of the sensor to the computer device as described later.

In a case where the sensor includes the three or more pairs of the first conductive parts and the second conductive parts, the length of one pair of the first conductive part and the second conductive part is preferably different from the lengths of the other pairs of the first conductive parts and the second conductive parts. In addition, in a case where the sensor includes the three or more pairs of the first conductive parts and the second conductive parts, the lengths of all the pairs of conductive parts may be different, or the length of at least one pair of conductive parts may be different.

In addition, in the second embodiment of the sensor system, a place where the sensor is installed and the number of sensors to be installed are not particularly limited, and can be designed as appropriate. For example, as in the first embodiment of the sensor system, a plurality of sensors may be installed at the river.

(Third Embodiment of Sensor System)

A sensor system according to a third embodiment of the present invention includes the above-described sensor. In addition, the sensor has the above-described configuration and the above-described function. Here, it is assumed that the internal impedance Z of the sensor, or the input voltage V_{IN} or the output voltage V_{OUT} in the voltage boost circuit or the voltage step-down circuit (hereinafter, referred to as the internal impedance Z or the like) is measured by the control part of the sensor, and information regarding the measured internal impedance Z or the like is transmitted to the computer device.

The input voltage V_{IN} measured by the sensor may be, for example, the input voltage V²_{IN} when the T_{off} period is sufficiently long and the current I becomes zero, and the output voltage V_{OUT} measured by the sensor may be, for example, the output voltage V²_{OUT} when the T_{off} period is sufficiently long and the current I becomes zero. Furthermore, the input voltage V_{IN} measured by the sensor may be, for example, the input voltage V²_{IN} at the time when the T_{off} period is started, and the output voltage V²_{OUT} measured by the sensor may be, for example, the output voltage V²_{OUT} at the time when the T_{off} period is started. The input voltage V²_{IN} at the start of the T_{off} period is a value dependent on the impedance Z as is clear from Equation (3) described above. Conversely, by measuring the input voltage V²_{IN}, the fluctuation of the input voltage including the impedance Z can be grasped. Therefore, the input voltage V²_{IN} at the start of the T_{off} period is effective as the measurement data.

The sensor is preferably installed at the river or the like. In addition, the sensor is preferably installed such that the longitudinal direction of the sensor is perpendicular to the water surface of the river or the like. Furthermore, the sensor is preferably installed such that the functional part 3 is on the upper side and the first conductive part 1 and the second conductive part 2 are on the lower side.

The functional part 3 of the sensor operates by the input voltage generated when at least a part of the first conductive part 1 and the second conductive part 2 comes into contact with the water of the river or the like. The operation of the functional part 3 of the sensor causes the communication part of the sensor to transmit the signal and the information regarding the internal impedance Z or the like of the sensor to the computer device. The computer device specifies the water level at the installation location of the sensor corresponding to the received signal.

The internal impedance Z or the like of the sensor measured by the sensor changes by a change in the contact area of the first conductive part 1 and the second conductive part 2 of the sensor with the water. That is, when the water level of the river or the like at the installation location of the sensor rises and the contact area of the first conductive part 1 and the second conductive part 2 of the sensor with the water increases, the internal impedance Z or the like of the sensor also changes. The information regarding the internal impedance Z or the like of the sensor measured by the sensor continues to be transmitted from the communication part of the sensor to the computer device.

The term continue is not limited to being temporally continuous or at regular intervals. For example, the information regarding the internal impedance Z or the like of the sensor may be transmitted at different intervals depending on a power supply situation from the first conductive part 1 and the second conductive part 2 of the sensor.

Note that the signal may be transmitted when the first conductive part 1 and the second conductive part 2 of the sensor come into contact with the water from a state where the first conductive part 1 and the second conductive part 2 are not in contact with the water, or may continue to be transmitted while the first conductive part 1 and the second conductive part 2 of the sensor are in contact with the water. Also in this case, the term continue is not limited to being temporally continuous or at regular intervals.

The computer device is not particularly limited as long as the computer device includes a communication part and a control part. Examples thereof include a server device and a terminal device. In a case where the computer device is the terminal device, it is preferable to install a sensor system application.

In addition, the computer device may include a storage part. A relationship between the internal impedance Z or the like of the sensor and the contact area of the first conductive part 1 and the second conductive part 2 of the sensor with the water may be measured in advance and stored in the computer device. Since the computer device stores in advance the relationship between the internal impedance Z or the like of the sensor and the contact area of the first conductive part 1 and the second conductive part 2 of the sensor with the water, it is easy to specify how much the first conductive part 1 and the second conductive part 2 of the sensor are in contact with the water from the information regarding the internal impedance Z or the like of the sensor. That is, it is easy to specify the water level at the installation location of the sensor from the information regarding the internal impedance Z or the like of the sensor.

Note that the computer device may be able to identify the sensor corresponding to the received signal. For example, as described above, the identification number may be assigned to the sensor, and the computer device may be able to specify to which sensor the received signal corresponds on the basis of the identification number.

In addition, the functional part of the sensor may specify the water level at the installation location of the sensor. In this case, the description of the first embodiment of the sensor system can be adopted within a necessary range as to how to specify the water level and transmit the information.

When at least a part of the first conductive part and the second conductive part comes into contact with the water, the functional part of the sensor transmits the information regarding the internal impedance and/or the voltage of the sensor to the computer device as described above. As a result, it is possible to continue to specify the water level at the installation location of the sensor.

In addition, the computer device may calculate the speed at which the water level of the river or the like at the installation location of the sensor rises on the basis of a time when the water level of the river or the like at the installation location of the sensor reaches a first predetermined water level and information on the water level thereof, and a time when the water level of the river or the like at the installation location of the sensor reaches a second predetermined water level and information on the water level thereof. At this time, the method of calculating the speed at which the water level rises described in the second embodiment can be adopted within a necessary range.

Furthermore, when the computer device receives the signal, the computer device may output information regarding the received signal.

For example, in a case where the computer device is the server device, the server device may transmit the information regarding the received signal to the terminal device. The terminal device may output a voice notifying that the signal has been received, may display a screen notifying that the signal has been received, or may display the information regarding the received signal.

Alternatively, in a case where the computer device is the terminal device, the terminal device may output the voice notifying that the signal has been received, may display the screen notifying that the signal has been received, or may display the information regarding the received signal.

In addition, the information regarding the received signal may include information regarding reception of the signal from the sensor, information regarding the installation location of the sensor corresponding to the received signal, information regarding the water level of the installation location of this sensor, information regarding the speed at which the water level rises calculated by the water level rising speed calculator, and the like.

Furthermore, in a case where the sensor system includes two or more of the sensors, the information regarding the received signal may include information regarding a flow area where the water level is estimated to rise by the water level rising estimator, information regarding the flowing water speed calculated by the flowing water speed calculator, information regarding whether or not the location is determined by the water level difference determiner that there is a difference between the water levels of the opposite banks, and the like. The description of the first embodiment of the sensor system can be adopted within a necessary range as to the method of calculating each information and the like.

In addition, in the third embodiment of the sensor system, a place where the sensor is installed and the number of sensors to be installed are not particularly limited, and can be designed as appropriate. For example, as in the first embodiment of the sensor system, a plurality of sensors may be installed at the river.

Furthermore, in the third embodiment of the sensor system, the outer appearance of the sensor is not particularly limited, and can be designed as appropriate. For example, the sensor may be the sensor where the hole that allows for installation of the sensor device at the installation location is not provided in the covering member, the sensor having the cylindrical main body, or the sensor having the tile-shaped main body.

(Fourth Embodiment of Sensor System)

A sensor system according to a fourth embodiment of the present invention includes the above-described sensor. In addition, the sensor has the above-described configuration and the above-described function. Here, the sensor includes the detection part that detects the state or property of water, and the functional part 3 transmits the information obtained by the detection part to the computer device. The detection part may be provided in the functional part 3.

In the fourth embodiment, the sensor is preferably installed such that at least a part of the first conductive part 1 and the second conductive part 2 is in contact with the water of the river or the like when there is no rain or the like and the water level of the river or the like is normal.

The functional part 3 of the sensor operates by the input voltage generated when at least a part of the first conductive part 1 and the second conductive part 2 comes into contact with the water of the river or the like. The operation of the functional part 3 of the sensor causes the detection part to detect the state or property of the water in contact with the first conductive part 1 and the second conductive part 2. The communication part of the sensor transmits the signal and information regarding the detected state or property of the water to the computer device.

The information regarding the state or property of the water may include various numerical values indicating the state or property of the water. For example, the information regarding the state or property of the water may include the temperature, dissolved oxygen concentration, salinity concentration, residual chlorine concentration, pH, oxidation-reduction potential (ORP), turbidity, and the like of the water.

Preferably, the information regarding the detected state or property of the water continues to be transmitted to the computer device while at least a part of the first conductive part 1 and the second conductive part 2 is in contact with the water of the river or the like.

The term continue is not limited to being temporally continuous or at regular intervals. For example, the information regarding the state or property of the water may be transmitted at different intervals depending on a power supply situation from the first conductive part 1 and the second conductive part 2 of the sensor.

In addition, in a case where various numerical values indicating the state or property of the water included in the information regarding the state or property of the water are different from predetermined values, the computer device may determine that the state or property of the water is in an abnormal state. In the case where it is determined that the state or property of the water is in the abnormal state, the computer device may notify that the state or property of the water is in the abnormal state.

As described above, the sensor includes the detection part that detects the state or property of the water, and the functional part transmits the information obtained by the detection part to the computer device. Therefore, it is possible to detect the state or property of the water of the river or the like at the installation location of the sensor without power supply from the outside.

The computer device is not particularly limited as long as the computer device includes a communication part and a control part. Examples thereof include a server device and a terminal device. In a case where the computer device is the terminal device, it is preferable to install a sensor system application.

In addition, the computer device may include a storage part. The storage part preferably stores the information regarding the state or property of the water of the river or the like at the installation location of the sensor. Since the storage part stores the information regarding the state or property of the water of the river or the like at the installation location of the sensor, the state or property of the water of the river or the like at the installation location of the sensor can be observed over a long period of time.

Furthermore, the computer device may be able to identify the sensor corresponding to the received signal. For example, as described above, the identification number may be assigned to the sensor, and the computer device may be able to specify to which sensor the received signal corresponds on the basis of the identification number.

In addition, when at least a part of the first conductive part 1 and the second conductive part 2 comes into contact with the water of the river or the like, the information regarding the water level at the installation location of the sensor, and/or the information regarding the internal impedance and/or the voltage of the sensor may be transmitted to the computer device, together with the signal and the information regarding the state or property of the water. At this time, the description of the first embodiment of the sensor system to the third embodiment of the sensor system can be adopted within a necessary range.

In a case where the sensor system includes two or more of the sensors, the computer device may estimate the rise in the water level downstream of the installation location of the sensor, calculate the flowing water speed between the installation locations of the sensors, and determine whether there is a difference between the water levels of the opposite banks. At this time, the description of the first embodiment of the sensor system can be adopted within a necessary range.

In addition, the computer device may calculate the speed at which the water level of the river or the like at the installation location of the sensor rises on the basis of a time when the water level of the river or the like at the installation location of the sensor reaches a first predetermined water level and information on the water level thereof, and a time when the water level of the river or the like at the installation location of the sensor reaches a second predetermined water level and information on the water level thereof. At this time, the description of the second embodiment of the sensor system can be adopted within a necessary range.

Furthermore, when the computer device receives the information regarding the state or property of the water, the computer device may output the received information. The description of the first embodiment of the sensor system to the third embodiment of the sensor system can be adopted within a necessary range as to the method of outputting the information.

In addition, in the fourth embodiment of the sensor system, a place where the sensor is installed and the number of sensors to be installed are not particularly limited, and can be designed as appropriate. For example, as in the first embodiment of the sensor system, the plurality of sensors may be installed at the river or the like.

Furthermore, in the fourth embodiment of the sensor system, the outer appearance of the sensor is not particularly limited, and can be designed as appropriate. For example, the sensor may be the sensor where the hole that allows for installation of the sensor device at the installation location is not provided in the covering member, the sensor having the cylindrical main body, or the sensor having the tile-shaped main body.

In the embodiment of the present invention, the “conductive part” may be, for example, made of any material as long as it is an energizable member. The “functional part” is, for example, a part that executes a predetermined function by energization. The function may be to convert electricity into energy such as light or heat, or to control a circuit.

In the embodiment of the present invention, the “voltage boost circuit” refers to, for example, a circuit that boosts and outputs an input voltage. The “voltage step-down circuit” refers to, for example, a circuit that steps down and outputs an input voltage. The “conductive polymer” refers to, for example, a polymer compound having electrical conductivity. The “carbon” refers to, for example, carbon fibers having conductivity. The “integrally forming” refers to, for example, joining different objects to each other, and more specifically, joining by a chemical and/or physical force such as adhesion using an adhesive, mechanical joining using another member, welding, and pressure bonding can be mentioned.

### APPLICATION EXAMPLES

Hereinafter, application examples according to the embodiment of the present invention will be described. The present invention is not limited to these application examples in any sense.

Since the sensor according to the embodiment of the present invention operates without power supply from the outside, the sensor can be installed at various places, and the cost for maintaining the sensor is low. Therefore, it is easy to install a plurality of sensors at various places in town in addition to the wall surface of a bridge girder, an embankment, and an irrigation channel.

When the river overflows, flooding spreads in town. By installing the plurality of sensors at various places in town, it is possible to grasp the flooding situation in town.

For example, the plurality of sensors may be installed at various places in town, and the sensor system application may display the installation locations of the sensors so that the installation locations can be grasped on a map. When at least a part of the first conductive part 1 and the second conductive part 2 of each sensor comes into contact with the water due to the overflow of the river or the like, the sensor transmits the signal. The installation location of the sensor corresponding to the received signal may be displayed in a different mode on the map so as to indicate that the installation location is flooded.

In addition, the sensor system application may be able to search for a route that is not flooded from a current location of a user to a shelter. In this case, the terminal device in which the sensor system application is installed is preferably equipped with the GPS. In addition, a conventionally known method can be used to search for the route.

By using such a sensor system application, the user can grasp the flooding situation in town on the map in real time. The user can evacuate along the route that is not flooded while checking the flooding situation in town.

Alternatively, when the signal is transmitted from the sensor according to the embodiment of the present invention, an electric water stop wall or water stop plate can be operated.

For example, when at least a part of the first conductive part 1 and the second conductive part 2 of the sensor comes into contact with the water and the signal is transmitted from the sensor to the computer device, the computer device that has received the signal may operate the electric water stop wall or water stop plate installed around the sensor.

As described above, it is possible to prevent the water from further spreading from the periphery of the sensor by operating the electric water stop wall or water stop plate when the signal is transmitted from the sensor.

### Reference Example

Hereinafter, the present invention will be described in more detail with reference to reference examples, but the present invention is not limited by these reference examples at all.

### Reference Example 1

The following test was performed at normal temperature and normal pressure. A circuit including the first conductive part 1, the second conductive part 2, the functional part 3, and the medium 4 illustrated in FIG. 1 was used. A plate-shaped member (0.5 mm thick, 10 cm×15 cm) made of stainless steel (austenite, SUS 304 series) was used as the first conductive part 1, a plate-shaped member (0.5 mm thick, 10 cm×15 cm) made of a galvanized steel plate (iron) was used as the second conductive part 2, and the first conductive part 1, the second conductive part 2, and the functional part 3 were connected to each other by copper conductive wires. The functional part 3 includes an electric consumption part, an output voltage conversion part, a communication part, and a control part. In addition, the functional part 3 having an input impedance of 1 kΩ or more and a non-linear current-voltage characteristic was used. As the electric consumption part, an LED bulb that lights up when a current of 2 mA or more flows was used. A voltage boost circuit illustrated in FIG. 2A was used as the output voltage conversion part to form a sensor as shown in FIG. 3.

The first conductive part 1 was connected to the input terminal A1 of the voltage boost circuit of the output voltage conversion part, and the output terminal B1 of the voltage boost circuit was connected to the LED bulb. Furthermore, the second conductive part 2 was connected to the input terminal A2 of the voltage boost circuit, and the output terminal B2 of the voltage boost circuit was connected to a terminal opposite to the terminal connected to the output terminal B1 of the LED bulb.

Pure water (KOGA Chemical Mfg Co., Ltd., high-purity purified water, temperature 25° C.: medium 4) was placed in an acrylic container (cubic body with outer diameter of 15 cm×15 cm×15 cm, inner diameter of 14.5 cm) up to a height of 7.5 cm, and the first conductive part 1 and the second conductive part 2 were immersed in the pure water to construct the sensor. The first conductive part 1 and the second conductive part 2 were not in contact with each other, the distance between the first conductive part 1 and the second conductive part 2 was 12 cm, and the first conductive part 1 and the second conductive part 2 were installed so that plate-like planes of the first conductive part 1 and the second conductive part 2 were parallel to each other.

For the constructed sensor, the voltage between the first conductive part 1 and the second conductive part 2 was measured (Measurement 1). For the measurement, a 34401A multimeter manufactured by Agilent Technologies was used. The result is shown in Table 1. In the sensor shown in Reference Example 1, the LED bulb repeatedly blinked every 270 to 330 seconds. That is, it was confirmed that electromotive force was generated from the first conductive part 1 and/or the second conductive part 2.

Next, the first conductive part 1 and the second conductive part 2 were immersed, and pure water (KOGA Chemical Mfg Co., Ltd., high-purity purified water, temperature 25° C.: medium 4) was placed in an acrylic container (cubic body with outer diameter of 15 cm×15 cm×15 cm, inner diameter of 14.5 cm) up to a height of 7.5 cm, and the first conductive part 1 and the second conductive part 2 were immersed in the pure water. The first conductive part 1 and the second conductive part 2 were not in contact with each other, the distance between the first conductive part 1 and the second conductive part 2 was 12 cm, and the first conductive part 1 and the second conductive part 2 were installed so that plate-like planes of the first conductive part 1 and the second conductive part 2 were parallel to each other. The first conductive part 1 and the second conductive part 2 were not electrically connected. Then, the voltage between the first conductive part 1 and the second conductive part 2 was measured using a 34401A multimeter (Measurement 2). Furthermore, in this state, the resistance value of the medium 4 between the first conductive part 1 and the second conductive part 2 was measured (Measurement 3).

### Reference Example 2

Measurements 1 to 3 were performed in the same manner as in Reference Example 1 except that the medium 4 was changed to soil (soil of house plant manufactured by PROTOLEAF, Inc.). The results are shown in Table 1. In the sensor shown in Reference Example 2, the LED bulb repeatedly blinked at substantially equal intervals every 21 to 23 seconds. That is, it was confirmed that electromotive force was generated from the first conductive part 1 and/or the second conductive part 2.

### Reference Example 3

Measurements 1 to 3 were performed in the same manner as in Reference Example 1 except that a waste cloth soaked in an aqueous solution in which 5 g of salt (Coarse Salt produced by Hakata Salt Co., Ltd.) was dissolved in 50 g of pure water (the same as in Reference Example 1) was attached to the surfaces of the first conductive part 1 and the second conductive part 2 in contact with the medium 4, and the medium 4 was changed to sand (silica sand having a particle size peak (weight ratio) of about 0.9 mm manufactured by Toyo Matelan Corporation). The results are shown in Table 1. In the sensor shown in Reference Example 3, the LED bulb repeatedly blinked every 80 to 100 seconds. That is, it was confirmed that electromotive force was generated from the first conductive part 1 and/or the second conductive part 2.

TABLE 1

| | Measurement 1 | Measurement 2 | Measurement 3 |
|---|---|---|---|
| | [mV] | [mV] | [kΩ] |
| Example 1 | 239 | 952 | 20 |
| Example 2 | 291 | 822 | 1,700 |
| Example 3 | 253 | 954 | 250 |

### Reference Example 4

Pure water placed in an acrylic container up to a height of 7.5 cm in Reference Example 1 was added up to a height of 10 cm. By adding pure water, it was possible to confirm a change in the internal impedance of the sensor described above. In addition, by adding pure water, a change in the input voltage V²_{IN} when the T_{off} period started was able to be confirmed. The internal impedance was calculated by the above-described calculation method.

### Reference Example 5

Water was added to the soil in Reference Example 2 to increase a water content. As a result, a change in the internal impedance of the sensor described above was able to be confirmed. In addition, by adding water, a change in the input voltage V²_{IN} when the T_{off} period started was able to be confirmed. The internal impedance was calculated by the above-described calculation method.

### REFERENCE SIGNS LIST

1 First conductive part
2 Second conductive part
3 Functional part
4 Medium
10 to 14 Sensor device
15 Covering member
16 Hole
17 Support column
18 Cylindrical main body
19 Tile-shaped main body
20 River

1. A sensor system comprising one or more sensors and a computer device capable of making a communication connection with the sensor,
the sensor including:
a first conductive part and a second conductive part; and
a functional part,
the first conductive part and the functional part being connected to each other,
the second conductive part and the functional part being connected to each other,
the first conductive part and the second conductive part being not in contact with each other, and
the functional part operating by an input voltage generated when at least a part of the first conductive part and the second conductive part comes into contact with water, and transmitting a signal to the computer device.

2. The sensor system according to claim 1, wherein
the computer device includes
a water level specifier configured to specify a water level at an installation location of the sensor corresponding to the received signal.

3. A sensor system comprising one or more sensors and a computer device capable of making a communication connection with the sensor,
the sensor including:
a first conductive part and a second conductive part; and
a functional part,
the first conductive part and the functional part being connected to each other,
the second conductive part and the functional part being connected to each other,
the first conductive part and the second conductive part being not in contact with each other, and
the functional part operating by an input voltage generated when at least a part of the first conductive part and the second conductive part comes into contact with water,
specifying a water level at an installation location of the sensor, and
transmitting a signal to the computer device.

4. The sensor system according to claim 1, wherein
the sensor includes two or more pairs of the first conductive parts and the second conductive parts, and
the functional part transmits, to the computer device, information for identifying the pair of the first conductive part and the second conductive part at least a part of which comes into contact with the water.

5. The sensor system according to claim 1, wherein
the functional part transmits, to the computer device, information regarding an internal impedance and/or a voltage of the sensor when at least a part of the first conductive part and the second conductive part comes into contact with the water.

6. The sensor system according to claim 4, wherein
the computer device includes
a water level rising speed calculator configured to calculate a speed at which the water level at the installation location of the sensor rises based on the received information and information on the specified water level.

7. The sensor system according to claim 1, wherein
the functional part includes
a voltage boost circuit or a voltage step-down circuit.

8. The sensor system according to claim 2, the sensor system comprising two or more of the sensors, wherein
the computer device includes
a water level rising estimator configured to estimate a rise in the water level downstream of the installation location of the sensor corresponding to the received signal according to the water level at the installation location of the sensor.

9. The sensor system according to claim 2, the sensor system comprising two or more of the sensors, wherein
the computer device includes
a flowing water speed calculator configured to calculate a flowing water speed between the installation locations of the sensors corresponding to the received signals based on information on the water level at the installation locations of the sensors.

10. The sensor system according to claim 2, the sensor system comprising the one or more sensors at each of opposite banks at a same position of a river, wherein
the computer device includes
a water level difference determiner configured to determine whether there is a difference between the water levels of the opposite banks.

11. The sensor system according to claim 1, wherein
the computer device includes
an outputter configured to output information regarding the received signal.

12. The sensor system according to claim 1, wherein
the sensor includes
a detection part configured to detect a state or a property of the water, and
the functional part transmits information obtained by the detection part to the computer device.

13. A sensor device comprising:
a first conductive part and a second conductive part; and
a functional part,
the first conductive part and the functional part being connected to each other,
the second conductive part and the functional part being connected to each other,
the first conductive part and the second conductive part being not in contact with each other, and
the functional part operating by an input voltage generated when at least a part of the first conductive part and the second conductive part comes into contact with water.

14. The sensor device according to claim 13, comprising two or more pairs of the first conductive parts and the second conductive parts.

15. The sensor device according to claim 13, comprising a covering member that covers a part or entirety of the sensor device, wherein
the covering member includes
a hole that allows for installation of the sensor device at an installation location.

16. The sensor device according to claim 13, wherein
two or more colors are applied to an outer appearance of the sensor device perpendicularly to a longitudinal direction of the sensor device.

17. The sensor device according to claim 13, wherein
the sensor device has a cylindrical main body, and
includes the first conductive part and the second conductive part having a sheet shape on an inner surface of a cylinder.

18. The sensor device according to claim 13, wherein
the sensor device has a tile-shaped main body, and
includes the first conductive part and the second conductive part having a sheet shape on a plane of a tile.

19. A sensing method in a sensor system comprising one or more sensors and a computer device capable of making a communication connection with the sensor,
the sensor including:
a first conductive part and a second conductive part; and
a functional part,
the first conductive part and the functional part being connected to each other,
the second conductive part and the functional part being connected to each other,
the first conductive part and the second conductive part being not in contact with each other, and
the functional part operating by an input voltage generated when at least a part of the first conductive part and the second conductive part comes into contact with water, and transmitting a signal to the computer device.

20. A sensing method in a sensor system comprising one or more sensors and a computer device capable of making a communication connection with the sensor,
the sensor including:
a first conductive part and a second conductive part; and
a functional part,
the first conductive part and the functional part being connected to each other,
the second conductive part and the functional part being connected to each other,
the first conductive part and the second conductive part being not in contact with each other, and
the functional part operating by an input voltage generated when at least a part of the first conductive part and the second conductive part comes into contact with water,
specifying a water level at an installation location of the sensor, and
transmitting a signal to the computer device.
